(19) United States
(12) Patent Application Publication
(10) Pub. No.: US 2016/0378928 A1
(43) Pub. Date: Dec. 29, 2016

(54) Therapist Assisted Mental Health Treatment Management System and Method

(71) Applicant: University of Florida Research Foundation, Inc., Gainesville, FL (US)

(72) Inventors: Sheryl A. Benton, Gainesville, FL (US); John Donaldson, Gainesville, FL (US); Geoffrey Lee, Gainesville, FL (US); Brian Shaw, Gainesville, FL (US); Aaron Thomas, Gainesville, FL (US)

(21) Appl. No.: 15/262,975

(22) Filed: Sep. 12, 2016

Related U.S. Application Data
(63) Continuation of application No. PCT/US2015/019244, filed on Mar. 6, 2015.
(60) Provisional application No. 61/951,818, filed on Mar. 12, 2014.

(51) Int. Cl. G06F 19/00

(52) U.S. Cl. CPC G06F 19/325; G06F 19/328

(57) ABSTRACT

Therapist assisted mental health management systems, processes and methods using a therapist remote therapy management computer in communication with a therapy central system cloud for storing plural queued learning modules corresponding to each of one or more different clients. A video conference system allows for confidential video consultation between a mental health therapist and one or more different clients (patients). The client (patient) communicates with the therapy central system cloud to access queued confidential learning modules from the therapy central system cloud. The systems, processes and methods can use interactive, educational treatment modules and periodic consultations with a counselor (therapist). The processes, methods and system can be viewable on a smart phone, tablet, and a computer. The methods, processes and systems can collect analytics on the performance of materials, exercises, and user experiences to continuously improve the system over time.

### CROSS REFERENCE TO RELATED APPLICATIONS

This application is a Continuation of PCT Application No. PCT/US2015/019244 filed Mar. 6, 2015, which claims the benefit of priority to U.S. Provisional Application Ser. No. 61/951,818 filed Mar. 12, 2014. The entire disclosure of each of the applications listed in this paragraph are incorporated herein by specific reference thereto.

### FIELD OF INVENTION

This invention relates to mental health treatment, and in particular to systems, processes and methods for therapist assisted therapy management of mental health treatment with a HIPAA compliant interface to a therapy central system cloud for a therapist to queue mental health learning modules with assigned homework with video conferencing between the therapist and client.

### BACKGROUND AND PRIOR ART

Approximately thirty-six percent of individuals with mental health problems in the United States receive treatment for their problems, and less than ten percent get Psychotherapy. According to the World Health Organization WHO, the United States has the highest rate of mental health problems among developed countries. Psychotherapy is a highly effective treatment, and generally more effective than many medications. Geography, socio-economic status, and insurance status impact access to psychotherapy. Psychotherapy is expensive and out of reach for many patients.

As every practicing psychologist knows, there is an urgent need for psychotherapeutic interventions that use less therapist time and fewer resources, with the same as or better outcomes than traditional face-to-face therapy. Currently each year approximately 18% of the adult population in the United States has an anxiety or mood disorder, corresponding to approximately 41 million people, but only approximately 15 million or approximately 37% receive treatment. Anxiety and mood disorders are among the top 10 most costly medical conditions in the United States. Total expenses are approximately $42 billion annually and outpatient visits, and costs approximately $10.5 billion annually.

Insurance companies struggle to reimburse this expensive treatment in the face of ever increasing demand and spiraling health care costs. Reimbursement rates have been repeatedly cut, and are dropping to or below break-even levels when practitioners consider their time, overhead, and staff costs. Moreover, availability of qualified mental health providers varies by geographical location and community. Even within the same state, appealing and affluent urban areas often have sufficient numbers of mental health providers, while other areas have too few. In the United States traditional psychotherapy is disproportionately accessible to white, urban, and affluent people, leaving most of the population with few if any treatment options.

Strategies that traditionally have been used to stretch services produce sub-optimal outcomes, have included waitlists, strict session limits, referring patients with more serious problems, and extending the time between sessions to once every three or four weeks.

Using depression as an example, in 2014 it is estimated that approximately twelve billion dollars will be spent on anti-depressant medication. However, according to the department of Health and Human Services Agency, only approximately 15-25 percent of people on anti-depressants will improve.

Psychotherapy is more effective than anti-depressant medication yet less than ten percent of the people that suffer with depression will get psychotherapy. Approximately sixty-four percent will get no treatment at all.

University and college counseling centers struggle with rising service demands without a corresponding increase in resources. According to professionals in the field, the number of students in need of treatment and the severity of diagnoses have climbed steadily during the past decade. Consequently, counseling centers must seek creative ways to not only maintain status quo, but rather expand capacity while preserving effectiveness. In other countries, therapist-assisted, internet delivered treatment has been effective in treating several common disorders while conserving one-third to one-half the per client therapist time.

Traditional psychotherapy is expensive and time consuming and the need for therapy exceeds supply in some settings such as in college counseling centers, the veterans' administration and community mental health centers. Another problem is that treatment often does not meet the patient's preference which leads to the patient dropping out of the therapy.

Thus, the need exists for solutions to the above problems with the prior art.

### SUMMARY OF THE INVENTION

A primary objective of the present invention is to provide systems, processes and methods for a therapist assisted electronic therapy management system for treating common mental health problems.

A secondary objective of the present invention is to provide systems, processes and methods for treatment of anxiety that includes interactive, on-line modules, the opportunity for group interaction entered anonymously, and weekly video conferencing with a therapist.

A third objective of the present invention is to provide systems, processes and methods for a platform that includes interactive, educational treatment modules for common mental health problems, with interventions from several theoretical perspectives and regular consultation with a counselor.

A fourth objective of the present invention is to provide systems, processes and methods for mental health treatment that is viewable on a smart phone, tablet, and a computer. Client progress and improvement would be viewable on a dashboard/screen both the client and counselor can see.

A fifth objective of the present invention is to provide systems, processes and methods for an electronic therapy management system for providing effective mental health treatment by licensed mental health professionals beyond the physical location of their practice to any area where they are licensed to provide mental health services.

A sixth objective of the present invention is to provide systems, processes and methods for customized mental health therapy learning modules and homework assignments under therapist control in combination with video conference mental health consultations with the therapist, where at least the brief contact with a therapist preserves the therapeutic relationship, thus combining the advantages of digital resources with the most important common factor in predicting client satisfaction.

A seventh objective of the present invention is to provide systems, processes and methods for a therapy management system that providing access to treatment for populations who have had historically had limited access to treatment.

An eighth objective of the present invention is to provide systems, processes and methods for an electronic therapy management system that allows for reminders and accountability to increase adherence and engagement when resources are made available to clients round the clock and seven days per week.

A ninth objective of the present invention is to provide systems, processes and methods for a therapy management system that allows for information to be gathered from clients (and patients) that can be used to assess treatment effectiveness from session to session and even intervention by intervention. This data collection allows for future advancements in individualizing and customizing treatments.

A first embodiment provides a cloud based therapy management system that includes a therapist remote therapy management computer, a therapy central system cloud for storing plural queued learning modules corresponding to one or more different clients (patients), a video conference system for confidential video consultation between a mental health therapist and the one or more different clients (patients), and a client (patient) therapy access device in communication with the therapy central system cloud forming a therapy managed network, queued confidential learning modules are queued into the therapy central system cloud and the queued learning modules are completed when the one or more different clients (patients) access the therapy central system cloud. The therapy central system cloud and video conference system includes a Health Insurance Portability and Accountability Act compliant interface.

Each patient therapy access can be assigned a different access identifier within the therapy central system cloud and a wireless communication interface between the therapy central system cloud and the client (patient) therapy device. The wireless communication interface can be a Wi-Fi communication interface between the therapy central system cloud and the client (patient) therapy device. The client (patient) therapy device can be a personal computer, a tablet, an iPad, or a cellular phone or smart phone. The client (patient) therapy access device can be a smart phone for receiving text reminders and encouragement messages.

The plural queued learning modules can include uploading treatment module, downloading treatment module, uploading reminder messages, downloading reminder messages, uploading treatment evaluations, downloading treatment evaluations, uploading client treatment feedback, and downloading client treatment feedback.

A second embodiment provides a method and process for cloud based mental health management that includes installing a therapy central system cloud at a mental health facility, with the therapy central system cloud assigned a network address as a node within a managed network of mental health offices, interfacing the therapy central system cloud with one or more therapy management computers at the mental health facility forming a node with a HIPAA compliant interface therebetween, queuing one or more learning modules, homework assignments, and feedback related to a patient within the node from the one or more therapy management computers into the therapy central system cloud, requesting one or more learning modules, homework assignments, and feedback related to the patient from a patient access device to the therapy central system cloud via a wireless communication interface, completing the one or more queued learning modules and homework assignments, and uploading the completed one or more learning modules and homework assignments to the therapy central system cloud for access from the therapy management computer.

The method can include queuing a video conference schedule from the therapy management computer into the therapy central system cloud, accessing the video conference schedule from the therapy central system cloud using the patient access device, and activating the video conference at the therapy management computers and the patient access device to complete a video consultation between a therapist and the patient; and can include uploading a progress status from the patient therapy access device via the wireless communication interface to the therapy central system cloud; and transmitting a reminder text message from a therapist text messaging device to the patient therapy access device.

The method can include applying an access control to ensure that only authorized therapists can queue learning modules and homework to the therapy central system cloud, and or assigning a unique identifier to the patient, and using the unique identifier by the patient (client) to access corresponding learning modules and homework from the therapy central system cloud.

The method can also include queuing a survey to the therapy central system cloud and accessing and completing the survey on the therapy central system cloud with the patient (client) therapy access device via the wireless communication interface.

The method can include collecting analytics on the patient (client) completion of the queued learning modules and homework assignments.

A method and system for cloud based mental health management can include the steps of installing a therapy central system cloud at a mental health facility, the therapy central system cloud being assigned a network address as a node within a managed network of mental health offices, interfacing the therapy central system cloud with plural therapy management computers at the mental health facility forming a node, providing tools for treating patients to increase patient engagement while decreasing time for interacting with therapists, providing the tools include an interactive online educational modules, providing the tools include scheduled video conferencing between the patients and the therapist, providing the tools include scheduled text messages between the therapists and the patients that provide support and encouragement, providing the tools include scheduled homework to be completed by the patients on wireless devices, providing the tools include selected progress measures to access mental health changes over time, and interacting use of the tools between the therapists and the patients through the therapy central system cloud and each therapy management computer.

The interactive online educational learning modules can be based on cognitive behavioral therapy (CBT), mindfulness and exposure.

The steps of providing the scheduled video conferencing and the scheduled text messages and the selected progress measures can be provided weekly between the therapists and the patients. The step of providing the homework can be completed daily.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a block diagram of a cloud based therapy management system.

FIG. 2 is a diagram of the therapist and client therapy interaction.

FIG. 3 shows an example of the online educational modules for the therapist assisted online system.

FIG. 4 show an example of a therapist assisted online log screen.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

A list of components will now be described.
100 therapy management computer
110 learning module database
120 client file
200 therapy central system cloud
250 HIPAA compliant interface
300 video conference system
400 patient therapy access device
410 learning resource system
420 downloaded learning modules and homework

The terms client and patient are used interchangeably throughout the following description and claims to refer to the recipient of the cloud based mental health therapy.

The present invention provides a mental health therapy management system and method for treating mental health problems. The system, processes and methods can be an alternative treatment option offered through counseling centers. Beyond counseling centers, the therapy management system can be a solution for providing effective treatment to underserved populations and allow licensed mental health professionals to provide effective services beyond the physical location of their practice to any area where they are licensed to provide services.

For example, the system, processes and methods can be used to treat anxiety and can include interactive, learning modules, the opportunity for group interaction entered anonymously, and periodic video conferencing with a therapist. While different metal health issues can be addressed using the therapy management system mental health treatment tools, the system, processes and methods of the present invention are described in relation to therapist assisted accessible anxiety treatment using interactive, educational treatment modules for common client (patient) problems, with interventions from several different perspectives. Periodic approximate 10 to approximate 15 minute consultations with a therapist can be included in these treatments.

In one embodiment, the mental health treatment management system, processes and methods can be viewable on client personal devices such as but not limited to a smart phone, tablet, and a personal computer. Client progress and improvements can be viewable on a dashboard (screen) that both the client and therapist have access for viewing.

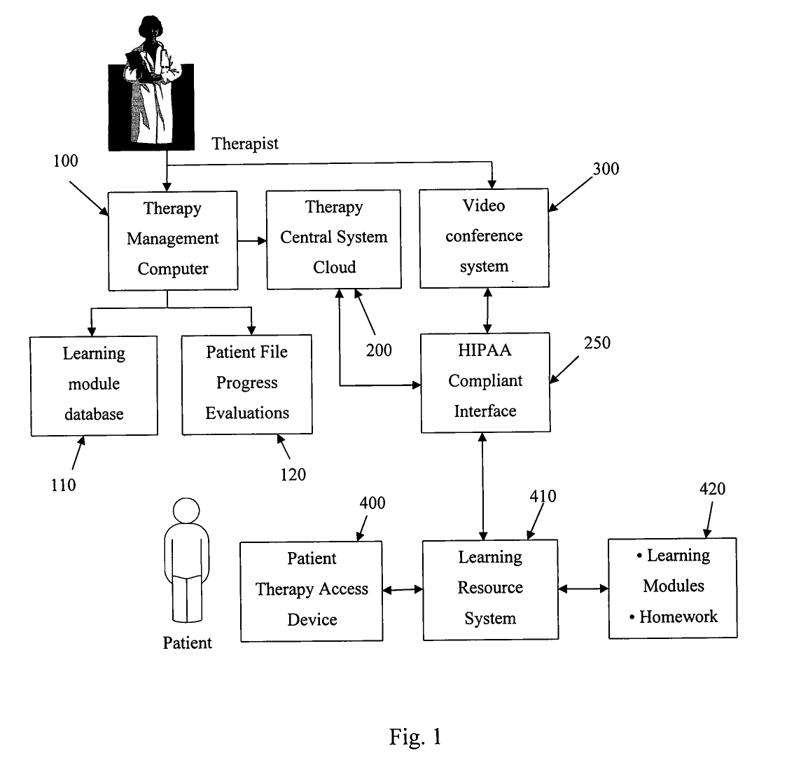

FIG. 1 is a block diagram of the cloud based therapy management system. As shown, the cloud based therapy management system includes a therapist remote therapy management computer 100, a therapy central system cloud 200 for storing plural queued learning modules corresponding to each of one or more different clients, a video conference system 300 for allowing confidential video consultation between a mental health therapist and the one or more different patients, and a patient therapy access device 400 in communication with the therapy central system cloud 200 forming a therapy managed network. Confidential learning modules from a database 110 with or without patient file progress evaluations 120 can be queued into the therapy central system cloud 200 and the queued learning modules are completed when the one or more different patients access the therapy central system cloud 200.

The therapy central system cloud 200 and video conference system 300 includes a Health Insurance Portability and Accountability Act (HIPAA) compliant interface 250. The interface 250 can include privacy protection, encryption, and a firewall and can be password protected. Thus, each patient therapy access can be assigned a different access identifier within the therapy central system cloud 200.

The system can include a wireless communication interface between the therapy central system cloud 200 and the patient therapy device 400. The wireless communication interface can be a Wi-Fi communication interface between the therapy central system cloud 200 and the patient therapy device 400 and the patient can use a variety of different wireless devices such as, but not limited to, a personal computer, a tablet, an iPad, and a cellular telephone and a smart phone.

The plural queued learning modules from database 110 can include uploading treatment module, downloading treatment module, uploading reminder messages, downloading reminder messages, uploading treatment evaluations, downloading treatment evaluations, uploading client treatment feedback, and downloading client treatment feedback.

Text messaging can be one of several tools that have been shown to improve patient engagement in treatment. Clients (patients) can choose to receive text message reminders about video conference sessions, as well as reminders to complete homework and educational modules. Such specific and personalized messages have been shown to be more effective than generic messages in promoting behavior change.

The mental health therapy management system, processes and methods can use online tools to keep client engagement and therapeutic intensity high with treatment educational materials with brief therapist contact through phone, chat, or video-conferencing. The treatment combines four tools associated with improved outcomes: text-message reminders, homework on mobile devices, video conference sessions, and a weekly progress measure done by and reviewed with the patient.

Research on the effectiveness of one psychological intervention over others has generally been equivocal. Most interventions outperform placebos, but little evidence supports the choice of one particular intervention over another. Nevertheless, several approaches have strong educational components that are quite conducive to online delivery. Examples can include but is not limited to: cognitive behavioral theory, acceptance and commitment theory, dialectical behavioral therapy, exposure, mindfulness, systematic desensitization, and solution-focused therapy. The mental health therapy management anxiety treatment is largely cognitive behavioral, with some exposure, systematic desensitization, and mindfulness.

For example, the treatment for anxiety can be based on behavioral theories and factors associated empirically with improved psychotherapy outcomes. Treatment can include several tools to increase the patient engagement each day, while decreasing the time interacting with therapists. The tools can include: (a) interactive online educational modules that are based on cognitive behavioral therapy (CBT), mindfulness, and exposure, (b) a weekly, 10-12 minute video conference with a therapist, (c) three weekly text messages for support and encouragement, (d) daily homework that can be completed on a smartphone or tablet or computer, and (e) a weekly progress measure to assess mental health changes over time.

In one example, the therapy management methods, processes and system can include seven interactive treatment modules meant to be completed during a seven-week period. It can include assessments of current symptoms and level of function, as well as cognitive—behavioral and mindfulness exercises. During the seven week period, patients can participate in approximately 10 to approximately 15 minute video consultations with their counselors once a week, and can receive reminders and encouraging text messages. The treatment program falls between self-help and traditional clinical therapy. The relationship between the therapist and the patient remains paramount. The video consultations and the content of the learning modules can work in concert with one another.

According to the present invention, the therapy management system, processes and methods provides advantages for mental-health professionals in higher education and their patients, which can include time and cost savings, the flexible and discreet nature of delivery, and the potential scalability as advantages. Healthcare costs can be reduced, cut in half, or reduced even further since the electronic therapy management system, processes and methods allows a therapy counselor to work with a plurality of patients, such as three patients per hour instead of only one. The weekly video conference can take up less than a third of the time spent in face-to-face therapy, freeing up counselors to work with individuals who are more seriously ill.

Patients using the therapy management system, processes and methods can complete the treatment modules as their schedules permit. This treatment model can help temper the stigma surrounding counseling-center visits, especially for patients from cultures in which discussing personal or family troubles remains taboo. The therapy management system, processes and methods can expand access to mental health professionals.

The evaluation of client progress in treatment is a powerful factor in improving therapeutic outcomes and measuring ongoing response to treatment and providing feedback to both the therapist and the clients (patients), significantly improved client (patient) outcomes. The mental health therapy management system, processes and methods includes a weekly monitoring instrument, the BHM-20, which is a published, validated measure of changes in symptoms, well-being, and life functioning. The therapist and client (patient) can review results each week which creates the opportunity for the therapist and client (patient) to tailor treatment towards more effective strategies and to shift treatment components when clients are not making progress.

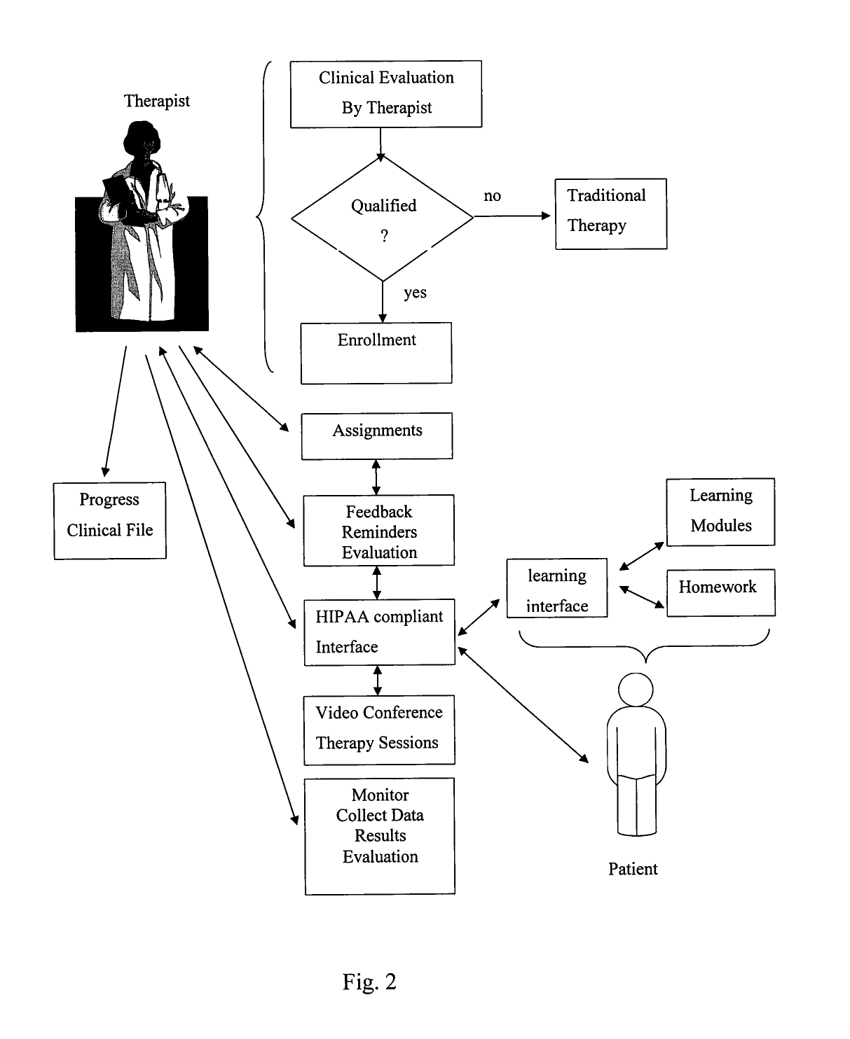

FIG. 2 shows the interaction between the therapist and the patient using the therapy management system. In this digital age, there are more tools available than existed in the past. Therapy can be self help, an application (App) for mobile devices, an Avatar based program and/or virtually reality. While self-help can be effective, the drop-out rates tend to hover around ninety percent. As shown, the therapy management system, processes and methods can include a secure therapy central system cloud (FIG. 1 & FIG. 2) for enrollment management with HIPAA compliant interfaces including privacy protection, encryption, firewalls and password protection. Data collection and evaluation of treatment components can use Tin Can API.

The Tin Can API (sometimes known as the Experience API or xAPI) is a specification for learning technology that makes it possible to collect data about the wide range of experiences a person has online and offline. This API captures data in a consistent format about a person or group's activities from many technologies. Very different systems are able to securely communicate by capturing and sharing this stream of activities using Tin Can's simple vocabulary.

As shown, the therapist management system, processes and methods can include video conferencing with the client using HIPAA compliant Web Real-Time Communication (WebRTC) video conferencing which also allows the counselor to monitor client participation and progress. WebRTC is an API definition being drafted by the World Wide Web Consortium (W3C) to enable browser-to-browser applications for voice calling, video chat, and P2P file sharing without plugins.

For example, treatment for anxiety in university counseling centers allows the patient to use a mobile communication device or computer where online interactive educational modules can be accessed, daily notification can be pushed to the client, and homework can be completed as shown in FIG. 2.

As previously described, the video conference with the counselor can be approximately 10 or approximately 15 minutes to allow the counselor to conference with more than one client (patient) per hour. The system can use a secure HIPAA compliant video conferencing service for sessions with clients and encrypted text messaging for communicating with clients (patients).

The therapy management system patient access can be, for example, built upon the Moodle learning management system (LMS), which is an open source platform used extensively throughout the world. The Moodie LMS controls enrollment, administration, and the delivery of materials to system users. In addition, the Moodle LMS contains substantial data that can be mined and used to improve the quality of the student experience.

Because current learning management systems lack the ability to deliver high quality integrated multimedia learning environments both to desktop computers and mobile devices, Rustici Software's SCORM Engine was integrated into Moodle to act as a content player and data collection tool. The SCORM Engine can play TAO customized learning activities and also includes a Learning Record Store (LRS) or database that collects granular usage data. This data is reported back to the Moodle LMS so as to provide reports to administrators and therapists.

Because the SCORM Engine includes a Learning Record Store or LRS that is designed to collect TinCan or xAPI statements, TAO customized mobile applications such as the monitoring logs can report to this database.

The xAPI can collect client activity within and outside of the learning management system thus expanding the boundaries of a traditional online learning environment. The fundamental idea of the TinCan is that a lot of learning takes place outside of the learning management system. Capturing these learning events outside of the learning management system promises to create a more powerful therapeutic tool as more apps are developed for and integrated with the therapy management system, processes and methods.

One of the essential components of the therapy management system solution is a high quality therapist to client synchronous tool. Tokbox provides a robust signaling solution with a low-latency signaling layer and HIPAA compliant security measures. This tool can be customized for the specific needs of therapists and is fully mobile friendly with cross-platform mobile apps. In addition, the Tokbox solution is fully scalable as users increase to the thousands and a restful API allows for custom integrations and data collection. The pricing structure of Tokbox also suits therapy management systems where cost is based upon usage rather than flat annual or monthly rates for licenses that may or may not be used.

Texting clients enrolled in therapy management system usage are essential tools to encourage client participation in the program and lower attrition. Texting can be through push notifications from the Droid and iOS apps, for example.

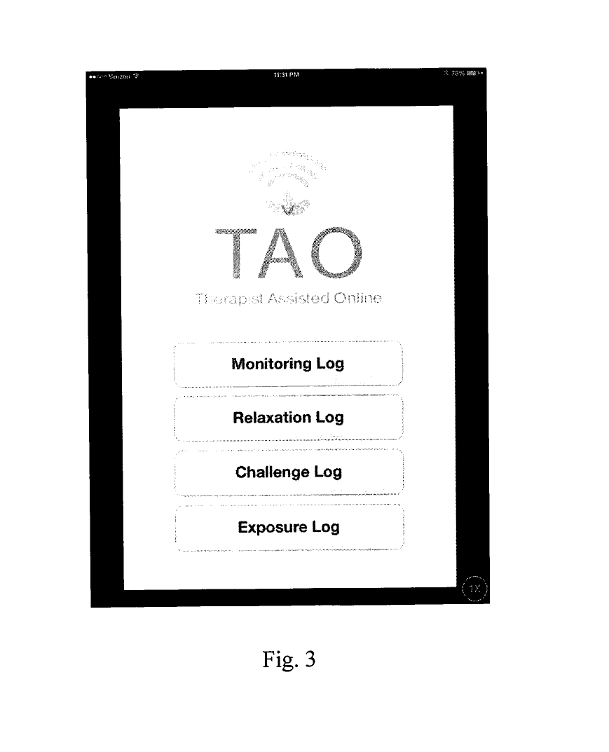

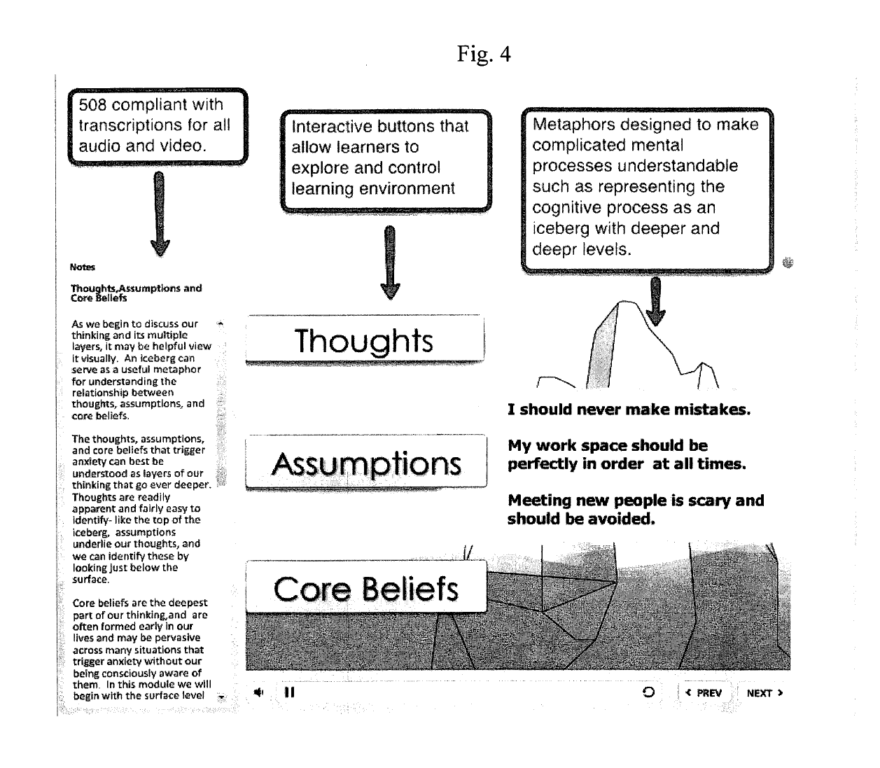

FIG. 3 shows an example of the online educational modules that can be used in the therapy management system. The online educational modules are 508 compliant with transcriptions for the audio and the video. FIG. 4 shows a screen shot of notes explaining the metaphor being used. The online module can include interactive buttons that allow learners to explore and to control the learning environment, in the example shown, the buttons include “thoughts”, “Assumptions”, and “Core beliefs”. The metaphor shown in the example is an iceburg with thoughts closer to the top of the berg and core beliefs are the deepest part of the thinking process as shown and as described in the notes. The client can proceed to the next page or return to the previous screen.

FIG. 4 shows an example of a therapist assisted online log screen. In the example shown, the therapy management system log screen allows the client (patient) and therapist to access the monitoring log, relaxation log, challenge log, and the exposure log. The logs shown are for example only and other logs can be added or removed.

The patient can be provided with a survey screen following a session asking to client to rate the therapy service, the types and quality of service provided, and the like. For example, the client (patient) can be asked to rate or comment on the overall session or on the videos displayed, relaxation exercises, and the like.

The mental health management system was tested using seventy-two participants self-selected for treatment. Potential participants were screened as shown in FIG. 2 through the counseling center. Potential participants who fit the following criteria were screened out and referred for face-to-face counseling: (a) active, serious suicidal ideation, (b) active, serious substance dependence, (c) discomfort with technology, and (d) severe symptoms and pathology that would best be treated face-to-face. Client familiarity with technology and access to video capable computer or mobile device were also considered as treatment assumes familiarity with several types of internet and communication technologies.

Clients were first given access and asked to log in to a secure web-portal that served as the online treatment platform. Once they successfully accessed the platform, they were instructed to complete a video orientation addressing key aspects of the online treatment including treatment session review, monitoring log utilization, mood survey completion and text reminders. Clients were also given the opportunity to test the secure video conferencing software that served as point of contact with treatment providers. Once clients (patients) endorsed familiarity with the software, they received an email with instructions for attending their weekly video conference and a secure weblink accessible only by the treatment provider and client at the agreed upon time. The final part of the orientation process included introducing clients (patients) to the text-based treatment reminder system.

At the conclusion of the screening process, clients (patients) were asked to complete all weekly treatment activities prior to their video conference with their treatment provider. These activities included reviewing the interactive learning modules, completing treatment homework through the website or the mobile app, providing programmatic feedback, and completing the BHM-2, prior to each individual session, or video conference the students completed the BHM-20.

Data analysis revealed a consistent pattern across the four outcome measures of Global Mental Health, Anxiety, Life Functioning, and Wellbeing. The results indicated that anxiety scores for college students treated online were better than those of students treated in traditional face-to-face treatment, which also showed significant improvement across time. Online clients had significantly greater improvement than clients undergoing standard treatment. Our data indicates that online treatment was a highly effective treatment, with regard to symptom reduction, life functioning, clients' sense of well being, and overall mental health.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A cloud based therapy management system comprising:
a therapist remote therapy management computer;
a therapy central system cloud;
treatment tools to increase patient engagement while decreasing time for interacting with therapists, the treatment tools include an interactive online educational modules adapted for patients, scheduled video conferencing through a video conferencing system between the patients and the therapist, scheduled text messages between the therapists and the patients that provide support and encouragement, homework to be completed by the patients on wireless devices, and selected progress measures to access mental health changes over time; and
online client therapy access devices adapted for each of the patients in communication with the therapy central system cloud and the therapist remote therapy management computer forming a therapy managed network.

2. The system of claim 1, wherein the therapy central system cloud and video conference system includes a Health Insurance Portability and Accountability Act compliant interface.

3. The system of claim 1, wherein the interactive online educational learning modules are based on cognitive behavioral therapy (CBT), mindfulness and exposure.

4. The system of claim 3, further comprising:
a wireless communication interface between the therapy central system cloud and each client therapy device.

5. The system of claim 4 wherein the wireless communication interface comprises:
a Wi-Fi communication interface between the therapy central system cloud and each client therapy device.

6. The system of claim 5, wherein each client therapy device is one or more of a personal computer, a tablet, a cellular telephone and a smart phone.

7. The system of claim 1, wherein the scheduled video conferencing and the scheduled text messages and the selected progress measures are weekly between the therapists and the patients.

8. The system of claim 7, wherein the homework is daily homework.

9. A method for cloud based mental health management comprising the steps of:
installing a therapy central system cloud at a mental health facility, the therapy central system cloud being assigned a network address as a node within a managed network of mental health offices;
interfacing the therapy central system cloud with one or more therapy management computers at the mental health facility forming a node with a HIPAA compliant interface therebetween;
health facility forming a node;
providing tools adapted for patients to increase patient engagement while decreasing time for interacting with therapists;
providing the tools include interactive online educational modules for the patients;
providing the tools include scheduled video conferencing between the patients and the therapist;
providing the tools include scheduled text messages between the therapists and the patients that provide support and encouragement;
providing the tools include homework to be completed by the patients on wireless devices;
providing the tools include selected progress measures to access mental health changes over time; and
interacting use of the tools between the therapists and the patients through the therapy central system cloud and each therapy management computer.

10. The method of claim 9, wherein the steps of providing the scheduled video conferencing and the scheduled text messages and the selected progress measures are provided weekly between the therapists and the patients.

11. The method of claim 10, wherein the step of providing the homework is completed daily.

12. The method of claim 9, further comprising the step of:
providing a Health Insurance Portability and Accountability Act (HIPA) compliant interface.

13. The method of claim 9 wherein the queuing step comprises the steps of:
uploading treatment module, downloading treatment module, uploading reminder messages, downloading reminder messages, uploading treatment evaluations, downloading treatment evaluations, uploading client treatment feedback, and downloading client treatment feedback, to and from the therapy central system cloud.

14. The method of claim 9, wherein the interactive online educational learning modules are based on cognitive behavioral therapy (CBT), mindfulness and exposure.

15. The method of claim 9, further comprising the steps of:
assigning a unique identifier to the patient; and
using the unique identifier by the patient to access corresponding learning modules and homework from the therapy central system cloud.

16. The method of claim 14, further comprising the step of:
using one of a smart phone, tablet and a personal computer to access corresponding learning modules and the homework from the therapy central system cloud.

17. The method of claim 9, further comprising the steps of:
queuing a survey to the therapy central system cloud; and
accessing and completing the survey on the therapy central system cloud with the patient therapy access device via the wireless communication interface.

18. The method of claim 9, further comprising the step of:
collecting analytics on the patient completion of the queued learning modules and homework assignments.

19. A method for cloud based mental health management comprising the steps of:
installing a therapy central system cloud at a mental health facility, the therapy central system cloud being assigned a network address as a node within a managed network of mental health offices;
interfacing the therapy central system cloud with plural therapy management computers at the mental health facility forming a node;
providing tools adapted for treating patients to increase patient engagement while decreasing time for interacting with therapists;
providing the tools include interactive online educational modules;
providing the tools include scheduled video conferencing between the patients and the therapists;
providing the tools include scheduled text messages between the therapists and the patients that provide support and encouragement;
providing the tools include scheduled homework to be completed by the patients on wireless devices;
providing the tools include selected progress measures to access mental health changes over time; and
interacting use of the tools between the therapists and the patients through the therapy central system cloud and each therapy management computer.

20. The method of claim 19, wherein the interactive online educational learning modules are based on cognitive behavioral therapy (CBT), mindfulness and exposure.
